(19) United States
(12) Patent Application Publication
(10) Pub. No.: US 2008/0204459 A1
(43) Pub. Date: Aug. 28, 2008

(54) Digital system for capturing and real-time outputting graphic

(75) Inventor: Ho-Jen Chen, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/710,535

(22) Filed: Feb. 26, 2007

(51) Int. Cl. G06F 15/00

(52) U.S. Cl. 345/501

(57) ABSTRACT

A digital system is provided for capturing and real-time outputting a graphic, which captures an external digital data and then converts it into a digital graphic for being output. The system includes a central processing unit (CPU), a graphic capture module, and a wireless output module or a storage module. Upon receiving a capture command, the CPU transmits a digital image formed by analyzing a digital data to the graphic capture module for capturing the digital image to generate a digital graphic. Finally, the digital graphic is written into the storage module or the wireless output module is used to output the digital graphic to an external receiving device, such that a user can obtain a required frame at any time.

### BACKGROUND OF THE INVENTION

1. Field of Invention

The present invention relates to a digital system for capturing and real-time outputting a graphic, and more particularly, to a digital system that converts a digital image into a digital graphic, and outputs the digital graphic to an external receiving device or write the digital graphic into a storage space of a storage module in real time.

2. Related Art

Currently, the digital TV sets available in the market are all mounted with a memory card slot, such that a user not only can play the digital graphics stored in a memory card on a digital TV set via the memory card slot, but also can select the graphic to be displayed by means of viewing a menu.

However, in order to capture the digital image on the digital TV set to form a digital graphic to be stored, a computer host is usually required to perform the image capture operation. The computer host must be provided with an image-capture card, a digital TV card, or connected with a digital TV box, for receiving the digital data. Then, the received digital image is registered in a memory or a built-in memory of the computer host via an audio-video recording software. After that, an image-capture software is used together with the image-capture card to capture the required frames so as to generate digital graphics in sheets, which are then stored in the storage device. However, if the stored image data is to be used on other electronic devices, the electronic device is connected to the computer host for performing operations of signal transmission or data transmission control.

However, the prior art has the following unavoidable defects, which include:

1. Real-time inadequacy, as the digital TV set does not have a real-time graphic capture function. As known from the above, a currently used digital TV set usually only has the function of reading the graphic information from a memory card, while the TV set itself does not have the image capture function, which thus is only equivalent to a picture browser. To capture some specific frames of the digital images, all of the digital images must be registered in the computer host before hand, and then, the image-capture software is used together with an image capture card to selectively capture the required frames, so as to form digital graphics, which is very complicated and time-consuming. On the other hand, when one watching TV programs in spare time, if there are some specific frames played on the TV set need to be stored, a general digital TV set cannot capture and store the frames in real time.

2. Convenience inadequacy, as a computer host is required for transferring a digital graphic to other electronic devices. As known from the above, a digital TV set itself does not have the frame capture function. Even if a data transmission interface connected to another electronic device is provided, the digital TV set still cannot capture and transmit a frame to the electronic device for later use. Secondly, the current technique of capturing an image to form a digital graphic must utilize a computer host for performing the capturing operation. To transfer the digital graphic to another electronic device, a connecting relationship and a data transmission channel must be established between each electronic device and the computer host before carrying out the operating signal transmission or data transmission. If the computer host itself does not have a data transmission interface for being connected to the electronic device, the digital graphic cannot be transferred.

3. Excessive high time cost. As known from the above, a computer host is required for capturing the digital image to form a digital graphic for being stored. However, to capture several digital images, the overall digital images must be stored in the memory of the computer host. After the storing process, the required frames must be detected step by step, such that the image-capture software is used to capture a frame and form a digital graphic, and thus the digital graphic can be stored into the storage device for being utilized by the user. However, merely the process for storing the digital images costs plenty of time, and it further consumes a time period to establish a connecting relationship between the electronic device and the computer host during the transferring of the digital graphic.

### SUMMARY OF THE INVENTION

In view of the above defects, the present invention is directed to providing a digital system that can capture a digital image being played back only by way of receiving a capture command in real time, and then generate a digital graphic for being output to an external receiving device or being written into a storage module, such that the user can obtain a digital graphic in a very short time.

In order to achieve the above object, the present invention provides a digital system for capturing and real-time outputting a graphic, which can capture and convert a received digital data into a digital graphic for being output to at least one external receiving device in real time. The digital system comprises a CPU, a graphic capture module, and a wireless output module. The CPU receives a digital data from the external of the digital system, and then converts it into a digital image through interpretation and analysis, and then outputs the digital image for being displaying. However, upon receiving a capture command, the CPU transfers the interpreted digital image to the graphic capture module. After receiving the digital image transferred from the CPU, the graphic capture module captures the digital image to generate a digital graphic and transfer the digital graphic to the wireless output module. At this time, the wireless output module establishes a data transmission channel with the external receiving device for transmitting the digital graphic to the external receiving device.

The present invention provides a method for capturing and real-time outputting a graphic, wherein a received digital data is captured and converted into a digital graphic for being output to at least one external receiving device. The method comprises: (a) receiving a digital data and converting it into a digital image for being output, and switching an output path of the digital image upon receiving a capture command; (b) receiving and capturing the digital image from the switched output path, for generating a digital graphic; and (c) establishing a wireless transmission channel with an external receiving device, for outputting the digital graphic to the external receiving device.

The present invention further provides a digital system for capturing and real-time outputting a graphic, which can capture a received digital data and convert it into a digital graphic for being stored into a storage module in real time. The digital system comprises a CPU, a graphic capture module, and a storage module. The CPU converts a digital data into a digital image through interpretation and analysis, and then outputs the digital image. Particularly, upon receiving a capture command, the CPU transfers the digital image to the graphic capture module. Then, the graphic capture module captures the required graphic information from the received digital image to generate a digital graphic, which is finally stored in the storage module.

The present invention further provides a method for capturing and real-time outputting a graphic, wherein a received digital data is captured and converted into a digital graphic for being stored in at least one storage module. The method comprises: (a) receiving a digital data and converting it into a digital image for being output, and switching an output path of the digital image upon receiving a capture command; (b) receiving and capturing the digital image from the switched output path, for generating a digital graphic; and (c) writing the digital graphic into the storage space of the storage module.

The present invention is directed to a digital system for capturing and real-time outputting a graphic, which has the following advantages compared with the prior art, as well as some significant efficacies.

(1) The real-time image capture is enhanced. In the prior art, an image capture card, a digital TV card, or a digital TV box is mounted on a computer host for storing digital images into the memory of the computer host. Then, an image-capture software is used to capture and generate a digital graphic for being stored in the storage module. However, the digital system of the present invention can rapidly capture the required frame of the digital image to form a digital graphic, only upon receiving a capture command, and then transmit the captured digital graphic to an external receiving device or store the captured digital graphic into a storage module for being used by the user. Thus, a computer host is not necessarily used to perform a complicated capture process.

(2) The digital graphic transferring process is simplified to improve the convenience. In the prior art, the computer host is connected to an electronic device to establish a transmission channel for transmitting the data to the electronic device. In the present invention, the digital system transmits the captured digital graphic to an external receiving device specified by the user in a wireless manner, such that the user can directly obtain and utilize the received digital graphic.

(3) The time cost is reduced. In the prior art, the digital image must be first stored in the memory of the computer host. Afterwards, the required frame must be detected step by step, such that the image-capture software is used to capture and convert the frame into a digital graphic. Finally, the digital graphic is stored into the storage module for being used by the user. However, in the present invention, the digital system can obtain the required digital graphic only upon receiving a capture command, and a computer host is not necessarily used to perform a complicated capture process. Thus, compared with the prior art, the present invention can greatly reduce the consumed time cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a system architectural view of a first preferred embodiment of the present invention;

FIG. 2 is a flow chart of a method according to the first preferred embodiment of the present invention;

FIG. 3 is a system architectural view of a second preferred embodiment of the present invention; and

FIG. 4 is a flow chart of a method according to the second preferred embodiment of the present invention.

### DETAILED DESCRIPTION OF THE INVENTION

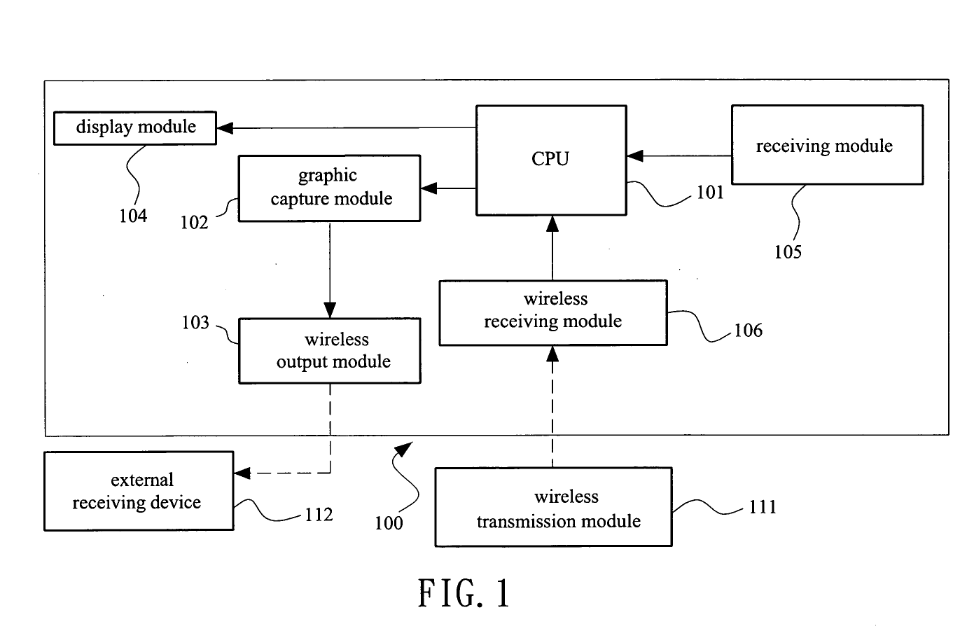

Referring to FIG. 1, it is a system architectural view of a first preferred embodiment of the present invention. The digital system 100 includes a display module 104, a graphic capture module 102, a wireless output module 103, a CPU 101, a wireless receiving module 106, and a receiving module 105. Moreover, an external receiving device 112 and a wireless transmission module 111 are disposed at the external of the digital system 100. The receiving module 105 is used to receive a digital data from the external of the digital system 100 and transmit it to the CPU 101. The CPU 101 receives the digital data, and interprets and analyzes it into a digital image for being output to the display module 104, which is used to display the digital image.

Upon receiving a capture command, the CPU 101 transmits the digital image to the graphic capture module 102. After receiving the digital image, the graphic capture module 102 captures the required graphic information from the received digital image to generate a digital graphic, and then, transmits the digital graphic to the wireless output module 103. Upon receiving the digital graphic, the wireless output module 103 first detects the external receiving device 112 for receiving the digital graphic, establishes a wireless transmission channel with the external receiving device 112, and then outputs the digital graphic to the external receiving device 112. The capture command is output by the wireless transmission module 111, and received by the wireless receiving module 106, which transfers the capture command to the CPU 101, such that the CPU 101 further transfers the digital image. The wireless output module 103 is an infrared data output device, radio frequency (RF) data output device, or an electronic data transmission device that outputs data in a wireless manner. The external receiving device 112 is an RF mobile phone, an infrared mobile phone, a blue-tooth mobile phone, a 3G mobile phone, a PDA, or any other portable consumer electronic device that is capable of establishing a wireless transmission channel with the wireless output module 103. The wireless transmission module 111 is an infrared signal remote control, an RF signal remote control, or an electronic signal transmission device that outputs signals in a wireless manner. The wireless receiving module 106 is an infrared signal receiver, an RF signal receiver, or an electronic signal receiving device that receives signals sent from the wireless transmission module 111 in a wireless manner. The digital system 100 can be optionally designed into an integrated digital TV set.

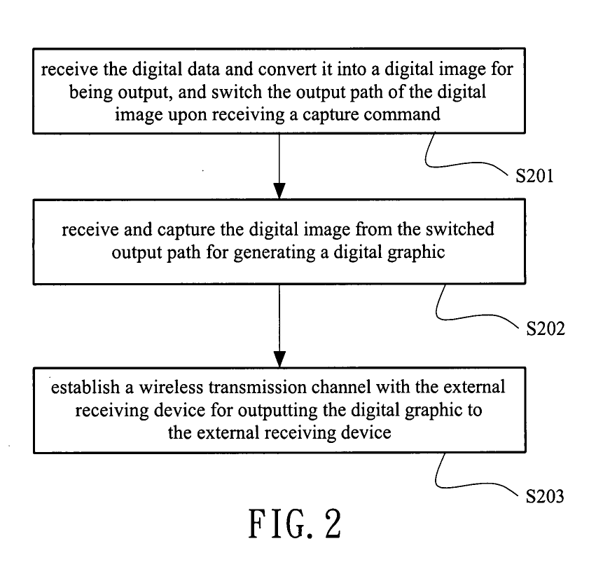

Referring to FIG. 2, it is a flow chart of a method according to the first preferred embodiment of the present invention, wherein the digital system 100 of the present invention captures a received digital data and converts it into a digital graphic, and then outputs the digital graphic to at least one external receiving device 112. The method includes the following steps.

In Step S201, the digital data is received and then converted into a digital image for being output, and the output path of the digital image is switched upon receiving a capture command. Before the capture command is sent by the user, the CPU 101 analyzes the received digital data and converts it into a digital image, which is then output to the display module 104 to be displayed. However, upon receiving the capture command, the CPU 101 transfers the analyzed digital image to the graphic capture module 102.

In Step S202, the digital image from the switched output path is received and captured for generating a digital graphic. Upon receiving the digital image transferred by the CPU 101, the graphic capture module 102 analyzes the digital image to obtain the required graphic information, so as to generate a digital graphic.

In Step S203, a wireless transmission channel is established with the external receiving device 112 for outputting the digital graphic to the external receiving device 112. The graphic capture module 102 first transmits the generated digital graphic to the wireless output module 103. The wireless output module 103 then outputs a detecting signal and records the external receiving device 112 that gives a response to the detecting signal, so as to establish a wireless transmission channel with the external receiving device 112, and then output the digital graphic to the external receiving device 112 via the wireless transmission channel.

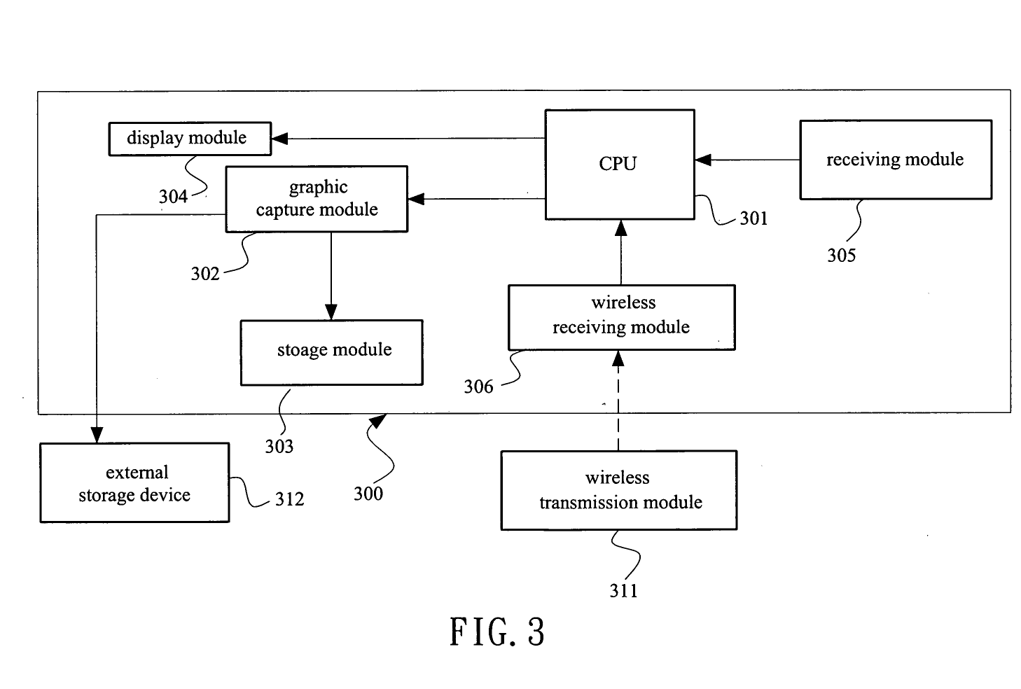

Referring to FIG. 3, it is a system architectural view of a second preferred embodiment of the present invention. The digital system 300 includes a display module 304, a graphic capture module 302, a storage module 303, a CPU 301, a wireless receiving module 306, and a receiving module 305. Moreover, a wireless transmission module 311 and an external storage device 312 are disposed at the external of the digital system 300. The receiving module 305 receives a digital data from the external of the digital system 300 and transmits it to the CPU 301. The CPU 301 receives the digital data, and interprets and analyzes the digital data into a digital image for being output to the display module 304, which is used to display the digital image analyzed by the CPU 301.

However, upon receiving a capture command, the CPU 301 transfers the digital image to the graphic capture module 302. After receiving the digital image, the graphic capture module 302 captures the required graphic information from the received digital image to generate a digital graphic, and writes the digital graphic into the storage module 303. Before the digital graphic is written, the storage module 303 first detects a file size of the digital graphic, plans a storage space for storing the digital graphic, and finally writes the digital graphic into the storage space. The capture command is output by the wireless transmission module 311, and received by the wireless receiving module 306, which transfers the capture command to the CPU 301, such that the CPU 301 transfers the digital image.

The storage module 303 is an optical disc recorder, a hard disc, a built-in memory, or a memory card slot for a memory card to be inserted. The digital system 300 is further connected to the external storage device 312, so as to establish a data transmission channel between the external storage device 312 and the graphic capture module 302. When the digital graphic is generated, the graphic capture module 302 directly writes the digital graphic into the external storage device 312, which is a USB flash disc, an external hard disc, an external memory slot, an external optical disc recorder, and an electronic storage device that is capable of being connected to the digital system 300 and establishing a data transmission channel with the graphic capture module 302.

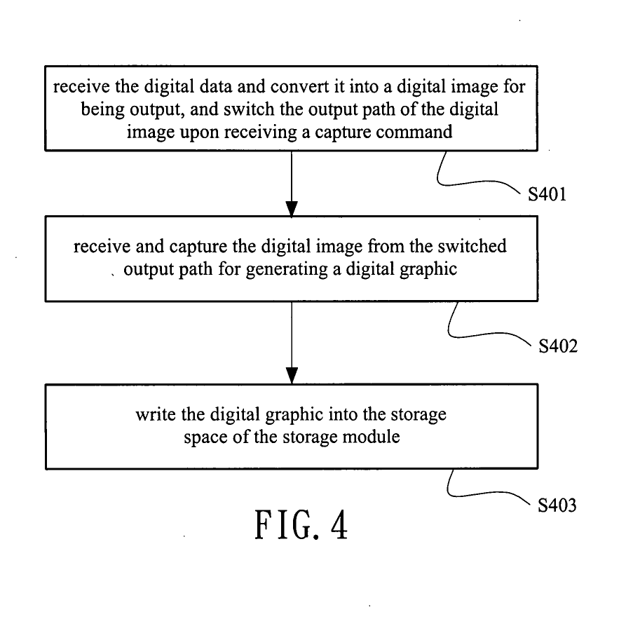

Referring to FIG. 4, it is a flow chart of a method according to the second preferred embodiment of the present invention, wherein the digital system of the present invention captures a received digital data and converts it into a digital graphic to be written into at least one storage module. The method includes the following steps.

In Step S401, the digital data is received and converted into a digital image for being output, and the output path of the digital image is switched upon receiving a capture command. Before the capture command is sent by the user, the CPU 301 analyzes the received digital data and converts it into a digital image, which is then output to the display module 304 to be displayed. However, upon receiving the capture command, the CPU 301 transfers the analyzed digital image to the graphic capture module 302.

In Step S402, the digital image from the switched output path is received and captured for generating a digital graphic. Upon receiving the digital image transferred by the CPU 301, the graphic capture module 302 analyzes the digital image to obtain the required graphic information, so as to generate a digital graphic.

In Step S403, the digital graphic is written into the storage space of the storage module 303. Before the digital graphic is written, the storage module 303 first detects a file capacity of the digital graphic, plans a storage space for storing the digital graphic, and then writes the digital graphic into the storage module 303.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital system for capturing and real-time outputting a graphic, which is applicable for capturing and converting a received digital data into a digital graphic for being output to at least one external receiving device in real time, the digital system comprising:
a central processing unit (CPU), for receiving and converting the digital data into a digital image for being output, and switching an output path of the digital image upon receiving a capture command;
a graphic capture module, electrically connected to the CPU, for receiving and capturing the digital image from the switched output path to generate the digital graphic; and
a wireless output module, electrically connected to the graphic capture module, and upon receiving the digital graphic, establishing a wireless transmission channel with the external receiving device, for outputting the digital graphic to the external receiving device.

2. The digital system for capturing and real-time outputting a graphic as claimed in claim 1, further comprising a receiving module, electrically connected to the CPU, for receiving the digital data from external of the digital system, and transmitting the received digital data to the CPU.

3. The digital system for capturing and real-time outputting a graphic as claimed in claim 1, further comprising a wireless receiving module, electrically connected to the CPU, for receiving the capture command, and transmitting the received capture command to the CPU.

4. The digital system for capturing and real-time outputting a graphic as claimed in claim 3, wherein the capture command is sent by a wireless transmission module.

5. A method for capturing and real-time outputting a graphic, which is applicable for capturing and converting a received digital data into a digital graphic, and then outputting the digital graphic to at least one external receiving device, the method comprising:
receiving and converting the digital data into a digital image for being output, and switching an output path of the digital image upon receiving a capture command;
receiving and capturing the digital image from the switched output path to generate the digital graphic; and
establishing a wireless transmission channel with the external receiving device to output the digital graphic to the external receiving device.

6. The method for capturing and real-time outputting a graphic as claimed in claim 5, wherein the step of establishing a wireless transmission channel with the external receiving device to output the digital graphic to the external receiving device further comprises a step of outputting a detecting signal and recording the external receiving device that gives a response, so as to establish the wireless transmission channel with the external receiving device.

7. A digital system for capturing and real-time outputting a graphic, which is applicable for capturing and converting a received digital data into a digital graphic for being stored in real time, the digital system comprising:
a central processing unit (CPU), for receiving and converting the digital data into a digital image for being output, and switching an output path of the digital image upon receiving a capture command;
a graphic capture module, electrically connected to the CPU, for receiving and capturing the digital image from the switched output path to generate the digital graphic; and
a storage module, electrically connected to the graphic capture module, for receiving the digital graphic, and writing the received digital graphic into a storage space of the storage module.

8. The digital system for capturing and real-time outputting a graphic as claimed in claim 7, further comprising a receiving module, for receiving the digital data from external of the digital system and transmitting the digital data to the CPU.

9. The digital system for capturing and real-time outputting a graphic as claimed in claim 7, further comprising a wireless receiving module, for receiving and transmitting the capture command to the CPU.

10. The digital system for capturing and real-time outputting a graphic as claimed in claim 9, wherein the capture command is sent by a wireless transmission module.

11. The digital system for capturing and real-time outputting the graphic as claimed in claim 7, wherein before the digital graphic is written, the storage module detects a file capacity of the digital graphic, and plans a storage space for the digital graphic to be written.

12. The digital system for capturing and real-time outputting a graphic as claimed in claim 7, further comprising an external storage device, for establishing a transmission channel with the graphic capture module, so as to obtain and then write the digital graphic into a storage space of the external storage device.

13. A method for capturing and real-time outputting a graphic, which is applicable for capturing and converting a received digital data into a digital graphic, and then storing the digital graphic into at least one storage module, the method comprising:
receiving and converting the digital data into a digital image for being output, and switching an output path of the digital image upon receiving a capture command;
receiving and capturing the digital image from the switched output path to generate the digital graphic; and
writing the digital graphic into a storage space of the storage module.

14. The method for capturing and real-time outputting a graphic as claimed in claim 13, wherein the step of writing the digital graphic into a storage space of the storage module further comprises a step of detecting a file capacity of the digital graphic, and planning the storage space for storing the digital graphic.
